(19) United States
(12) Patent Application Publication
(10) Pub. No.: US 2014/0047928 A1
(43) Pub. Date: Feb. 20, 2014

(54) PRESSURE DETECTION DEVICE

(71) Applicants: HON HAI PRECISION INDUSTRY CO., LTD., New Taipei (TW); Hong Fu Jin Precision Industry (ShenZhen) Co., Ltd, Shenzhen (CN)

(72) Inventors: YAN-CHENG BAO, Shenzhen (CN); AI-JUN TANG, Shenzhen (CN)

(21) Appl. No.: 13/912,394

(22) Filed: Jun. 7, 2013

(30) Foreign Application Priority Data
Aug. 16, 2012 (CN) 2012102918574

(51) Int. Cl. G01L 5/00

(52) U.S. Cl. CPC G01L 5/00
USPC 73/862.541

(57) ABSTRACT

A pressure detection device includes a supporting member, a pressure sensor, a force transmission member, and a limiting member. The supporting member includes a receiving portion and a mounting portion protruding from an end of the receiving portion. The pressure sensor is fixedly received in the receiving portion of the supporting member. The force transmission member includes a main body received in the mounting portion, a transmission portion and an assembly portion protruding from opposite ends of the main body, the transmission portion fixedly extending through the pressure sensor. The limiting member extends through the assembly portion and is fixedly connected to the mounting portion of the supporting member, thereby preventing the force transmission member from rotating. The assembly portion of the force transmission member protrudes from the supporting member, and abuts against an end of the supporting member.

### BACKGROUND

1. Technical Field

The present disclosure relates to a detection device, and more particularly, to a pressure detection device.

2. Description of Related Art

A grinding robot is employed to grind a workpiece in industrial area. The grinding robot includes a robot arm, a pressure detection device, and a grinding machine. The pressure detection device interconnects with the robot arm and the grinding machine. The pressure detection device detects and adjusts an amount of pressure force created by the grinding machine to be exerted on the workpiece. The pressure detection device includes a pressure sensor and a force transmission member connected to the pressure sensor. The force transmission member includes a main body and a mounting portion protruding from an end of the main body. The pressure sensor is mounted on the main body, and the grinding machine is connected to the mounting portion. When grinding a workpiece, an amount of torsion generated on the mounting portion may be exerted on the pressure sensor. Therefore, a detection precision of the pressure sensor is thereby reduced.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a pressure detection device configured with a grinding device.

FIG. 2 is an exploded, isometric view of the pressure detection device of FIG. 1.

FIG. 3 is similar to FIG. 2, but viewed from another aspect.

FIG. 4 is a cross-sectional view of the pressure detection device of FIG. 1, taken along line IV-IV.

### DETAILED DESCRIPTION

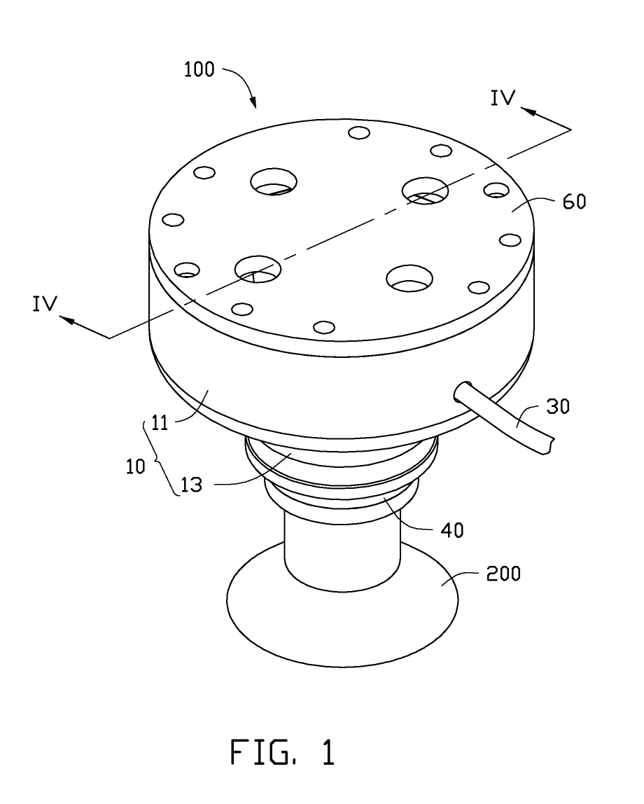

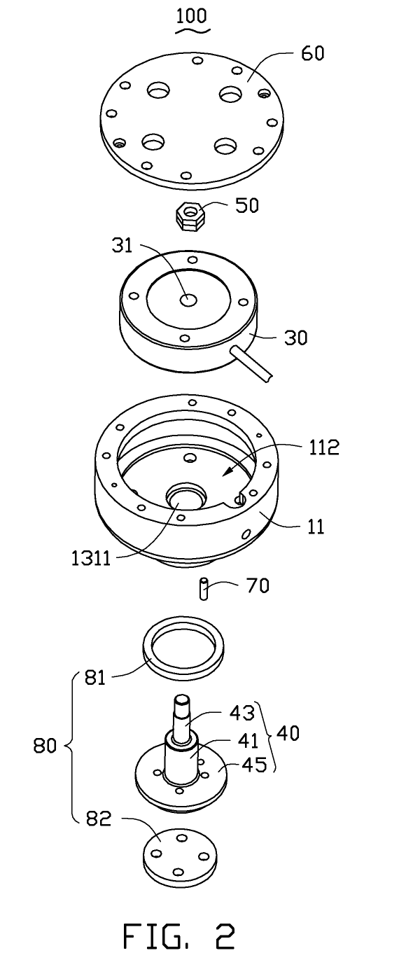

FIGS. 1 and 2 show an embodiment of a pressure detection device 100. The pressure detection device 100 interconnects a robot arm (not shown) and a grinding device 200. The pressure detection device 100 is occupied to detect a pressure force of the grinding device 200 that is exerted on a workpiece. The pressure detection device 100 includes a supporting member 10, a pressure sensor 30 received in the supporting member 10, a force transmission member 40, a locking member 50, an overload protection cover 60, a limiting member 70, and a buffering assembly 80. The force transmission member 40 extends through the supporting member 10 and the pressure sensor 30. The locking member 50 is fixed to an end of the force transmission member 40. The limiting member 70 is partially received in the supporting member 10. The overload protection cover 60 and the buffering assembly 80 are mounted on opposite ends of the supporting member 10, respectively.

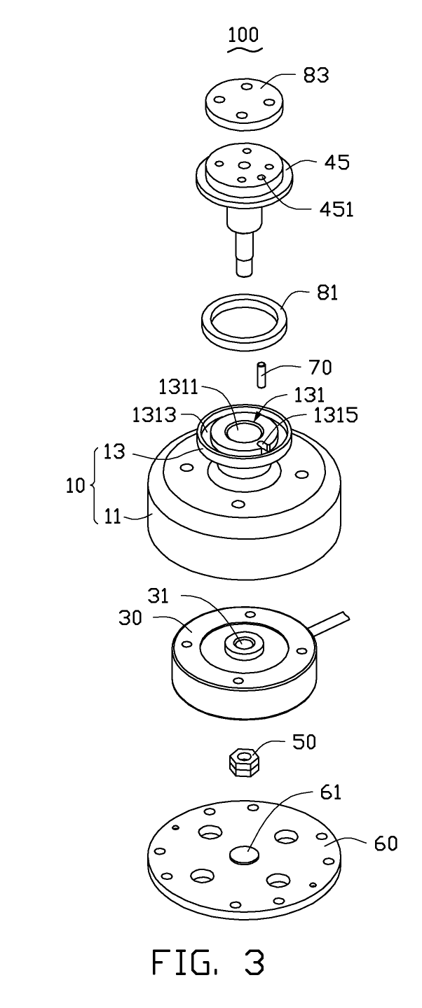

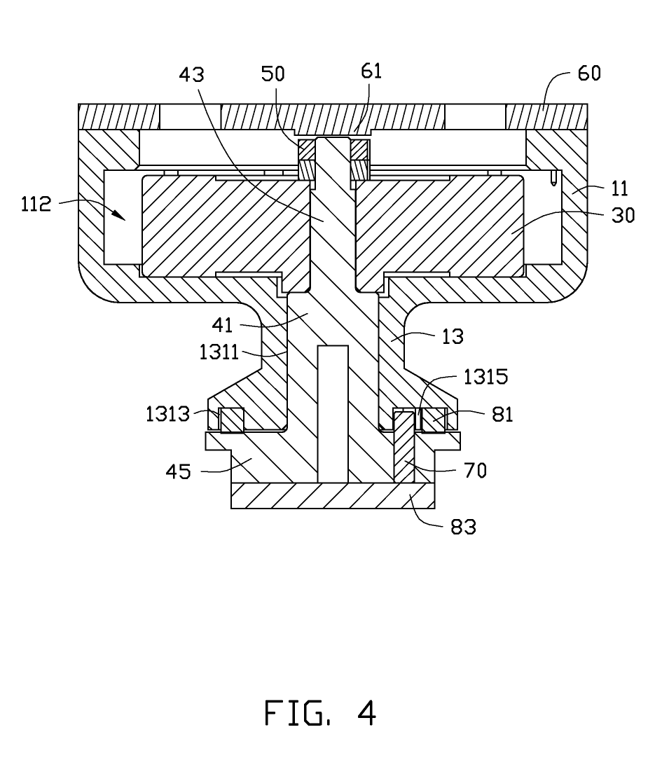

Also referring to FIGS. 3 and 4, the supporting member 10 includes a receiving portion 11 and a mounting portion 13 protruding from an end of the receiving portion 11. The receiving portion 11 is substantially cylindrically, and defines a receiving chamber 112 at an end thereof away from the mounting portion 13. The mounting portion 13 is in a cylindrical shape, and coaxial with the receiving portion 11. The mounting portion 13 defines a mounting surface 131 at an end thereof away from the receiving portion 11, and a mounting hole 1311 on the mounting surface 131. The mounting portion 13 further defines a receiving groove 1313 and a positioning groove 1315 on the mounting surface 131. The mounting hole 1311 communicates with the receiving chamber 112. In the illustrated embodiment, the receiving groove 1313 is annular, being arranged along a periphery of the mounting surface 131, and surrounding the mounting hole 1311. The receiving groove 1313 is coaxial with the mounting hole 1311. The positioning groove 1315 extends from an inner side surface of the receiving groove 1313 towards the mounting hole 1311 along a radial direction of the mounting portion 13. The positioning groove 1315 is a blind groove.

The pressure sensor 30 is fixedly received in the receiving chamber 112 of the supporting member 10. The pressure sensor 30 defines an extending hole 31 thereon coaxial with the mounting hole 1311 of the mounting portion 13. The extending hole 31 communicates with the mounting hole 1311. In the illustrated embodiment, the extending hole 31 is axially defined in a central portion of the pressure sensor 30, and engages with the force transmission member 40.

The force transmission member 40 is partially received in the supporting member 10. The force transmission member 40 includes a main body 41, a transmission portion 43 and an assembly portion 45. The transmission portion 43 and the assembly portion 45 are formed on opposite ends of the main body 41, respectively. The main body 41 is substantially cylinder shaped, and received in the mounting hole 1311 of the supporting member 10. The transmission portion 43 extends through and engages with the extending hole 31 of the pressure sensor 30, and an end of the transmission portion 43 protrudes out of the extending hole 31. The assembly portion 45 protrudes out of the supporting member 10, abuts against the mounting surface 131, and connects with the grinding device 200. The assembly portion 45 defines a limiting hole 451 therethough corresponding to the positioning groove 1315 of the mounting portion 13.

The locking member 50 is mounted on an end of the transmission portion 43 away from the assembly portion 45. The locking member 50 presses on the pressure sensor 30 to retain the pressure sensor 30 in the receiving chamber 112. In the embodiment, the locking member 50 is exemplified in the form of two nuts arranged side by side. The locking member 50 may also a single nut.

The overload protection cover 60 is assembled to the receiving portion 11 of the supporting member 10, thereby sealing the receiving chamber 112. The overload protection cover 60 includes an overload protection portion 61 configured in a central portion thereof corresponding to the transmission portion 43 of the force transmission member 40. The overload protection portion 61 is spaced from the transmission portion 43 at a distance to meet grounding requirement. When the grinding device 200 is overloaded, the transmission portion 43 is capable of moving toward the overload protection cover 60, and resisting the overload protection portion 61, thus allowing the overload protection portion 61 to resist the force transmission member 40 to protect the pressure detection device 100.

The limiting member 70 is substantially in a cylindrical shape, and extends through the limiting hole 451. An end of the limiting member 70 is fixedly received in the positioning groove 1315 of the supporting member 10 to prevent a rotation of the force transmission member 40 relative to the supporting member 10.

The buffering assembly 80 is assembled to the assembly portion 45 of the force transmission member 40. The buffering assembly 80 includes a sealing member 81 and a rubber buffering plate 83. The sealing member 81 is annular and made of soft rubber. The sealing member 81 is received in the receiving groove 1313 of the supporting member 10. The rubber buffering plate 83 is adhered to the assembly portion 45 by glue. The rubber buffering plate 83 is located at an end surface of the assembly portion 45 away from the overload protection cover 60. The rubber buffering plate 83 is capable of buffering vibrations of the grinding device 200, thereby enhancing or improving a detection precision of the pressure sensor 30.

When being assembled, the pressure sensor 30 is received in the receiving chamber 112 of the supporting member 10. The transmission portion 43 of the force transmission member 40 extends though the mounting hole 1311 of the supporting member 10 and the extending hole 31 of the pressure sensor 30. An end of the transmission portion 43 protrudes out of the pressure sensor 30. The locking member 50 is mounted on the end of the transmission portion 43 to assembly the pressure sensor 30 to the force transmission member 40. The limiting member 70 extends through the limiting hole 451 of the force transmission member 40, and partially receives in the position groove 1315 by an end thereof. The overload protection cover 60 is fixedly mounted on the receiving portion 11, with the overload protection portion 61 aligned to the transmission portion 43. The sealing member 81 is received in the receiving groove 1313, and the rubber buffering plate 83 is adhered to the assembly portion 45.

When in use, the overload protection cover 60 is connected to the robot arm, the assembly portion 45 of the force transmission member 40 is assembled to the grinding device 200. When the grinding device grinds the workpiece, the grinding device exerts a force on the workpiece, and a counter-acting force is generated by the workpiece toward the assembly portion 45. The counter-acting force is conducted or transferred to the pressure sensor 30 perpendicularly by the force transmission member 40. When the counter-acting force exceeds a load capacity of the pressure sensor 30, the pressure sensor 30 is balanced toward the overload protection cover 60, and the transmission portion 43 of the force transmission member 40 moves toward and resists on the overload protection portion 61. Then, the pressure sensor 30 is prevented from being damaged.

The assembly portion 45 resists on the mounting portion 13, and the limiting member 70 extends through the assembly portion 45, and is fixedly received in the positioning groove 1315 of the supporting member 10 at an end thereof, such that when a torsion is created or exerted on the assembly portion 45 by the grinding machine or device, it can be balanced by the mounting surface 131 of the supporting member 10, thereby enhancing the detection precision of the pressure sensor 30. In addition, due to the presence of the overload protection cover 60, the pressure sensor 30 can be prevented from damaged. Furthermore, the rubber buffering plate 83 and the sealing member 81 are capable of buffering the vibrations from the grinding device.

When the pressure sensor 30 defines a threaded hole engaging with the transmission portion 43 of the force transmission member 40, the locking member 50 may be omitted. The overload protection cover 60 and the buffering assembly 80 may be omitted.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A pressure detection device configurable with a grinding device, comprising:
a supporting member comprising a receiving portion and a mounting portion protruding from an end of the receiving portion;
a pressure sensor fixedly received in the receiving portion of the supporting member;
a force transmission member comprising a main body received in the mounting portion, a transmission portion and an assembly portion protruding from opposite ends of the main body, the transmission portion extending through the pressure sensor; and
a limiting member extending through the assembly portion and fixedly connected to the mounting portion of the supporting member, thereby preventing the force transmission member from rotating;
wherein the assembly portion of the force transmission member protrudes from the supporting member, and abuts against an end of the supporting member for counter-balancing a torsion created on the assembly portion by the grinding device.

2. The pressure detection device of claim 1, further comprising an overload protection cover assembled to the receiving portion of the supporting member, wherein the overload protection cover comprises an overload protection portion, the overload protection portion is spaced from the transmission portion, when the pressure detection device is overloaded, the transmission portion is capable of moving toward the overload protection cover, and resisting the overload protection portion.

3. The pressure detection device of claim 1, wherein an end of the transmission portion of the force transmission member protrudes out of the pressure sensor, the pressure detection device further comprises a locking member mounted on the end of the transmission portion, the locking member presses on the pressure sensor to retain the pressure sensor.

4. The pressure detection device of claim 1, wherein the locking member is comprising of two nuts arranged side by side, and the two nuts are sleeved on the end of the transmission portion of the force transmission member.

5. The pressure detection device of claim 3, wherein the mounting portion defines a mounting surface at an end thereof away from the receiving portion and a mounting hole on the mounting surface, the mounting hole communicates with the receiving chamber, the main body of the force transmission member is received in the mounting hole, the assembly portion abuts against the mounting surface.

6. The pressure detection device of claim 5, wherein the pressure sensor defines an extending hole at a central portion axially thereof, the extending hole is coaxial with the mounting hole, the transmission portion of the force transmission member extends through the extending hole and engages with the extending hole.

7. The pressure detection device of claim 5, wherein the mounting portion further defines a receiving groove and a positioning groove on the mounting surface, the receiving groove is annular, being arranged along a periphery of the mounting surface, and surrounding the mounting hole, the positioning groove extends from an inner side surface of the receiving groove toward the mounting hole along a radial direction of the mounting portion, the limiting member is fixedly received in the positioning groove by an end thereof.

8. The pressure detection device of claim 7, further comprising a buffering assembly, wherein the buffering assembly comprises a sealing member and a rubber buffering plate, the sealing member is received in the receiving groove of the supporting member, the rubber buffering plate is adhered to the assembly portion.

9. A pressure detection device, comprising:
a supporting member comprising a receiving portion and a mounting portion protruding from an end of the receiving portion;
a pressure sensor fixedly received in the receiving portion of the supporting member;
a force transmission member comprising a main body received in the mounting portion, a transmission portion and an assembly portion protruding from opposite ends of the main body, the transmission portion being fixed to the pressure sensor;
a limiting member extending through the assembly portion and fixedly connected to the mounting portion of the supporting member, thereby preventing the force transmission member from rotating; and
an overload protection cover assembled to the receiving portion of the supporting member, the overload protection cover comprising an overload protection portion;
wherein the assembly portion of the force transmission member protrudes from the supporting member and abuts against an end of the supporting member, an end of the transmission portion protrudes out of the pressure sensor and is aligned to the overload protection portion, when the pressure detection device is overloaded, the transmission portion moves toward the overload protection cover and resists the overload protection portion.

10. The pressure detection device of claim 9, wherein the overload protection portion is spaced from the transmission portion.

11. The pressure detection device of claim 9, wherein the end of the transmission portion extends through the pressure sensor, the pressure detection device further comprises a locking member mounted on the end of the transmission portion, the locking member presses on the pressure sensor to retain the pressure sensor.

12. The pressure detection device of claim 9, wherein the locking member is in the form of two nuts arranged side by side, and sleeved on the end of the transmission portion of the force transmission member.

13. The pressure detection device of claim 11, wherein the mounting portion defines a mounting surface at an end thereof away from the receiving portion and a mounting hole on the mounting surface, the mounting hole communicates with the receiving chamber, the main body of the force transmission member is received in the mounting hole, the assembly portion abuts against the mounting surface.

14. The pressure detection device of claim 13, wherein the pressure sensor defines an extending hole at a central portion axially thereof, the extending hole is coaxial with the mounting hole, the transmission portion of the force transmission member extends through the extending hole and engages with the extending hole.

15. The pressure detection device of claim 13, wherein the mounting portion further defines a receiving groove and a positioning groove on the mounting surface, the receiving groove is annular, arranged along a periphery of the mounting surface, and surrounding the mounting hole, the positioning groove extends from an inner side surface of the receiving groove toward the mounting hole along a radial direction of the mounting portion, the limiting member is fixedly received in the positioning groove by an end thereof.

16. The pressure detection device of claim 15, further comprising a buffering assembly, wherein the buffering assembly comprises a sealing member and a rubber buffering plate, the sealing member is received in the receiving groove of the supporting member, the rubber buffering plate is adhered to the assembly portion.
